(19) United States
(12) Patent Application Publication
(10) Pub. No.: US 2003/0046135 A1
(43) Pub. Date: Mar. 6, 2003

(54) Method and apparatus for automated timesheet and other related information recording, processing and visualisation

(76) Inventors: Richard James Cartwright, Alexandria (AU); Michael Adam Potas, Alexandria (AU)

Correspondence Address: GREENBERG TRAURIG, P.C., 77 WEST WACKER DRIVE, CHICAGO, IL, 60601-1732, US

(21) Appl. No.: 10/177,188

(22) Filed: Jun. 20, 2002

(30) Foreign Application Priority Data
Jun. 20, 2001 (AU) PR5828

(51) Int. Cl. G06F 17/60

(52) U.S. Cl. 705/8

(57) ABSTRACT

A method of compiling data about the use of programs being used on a computer system by at least one user is disclosed. The method includes the steps of:

(a) running a Task Logger program on the computer system to monitor the action of each user on their workstation to determine the use by each user during any predetermined period;

(b) entering data to a user private database about the use of each user, each user having at least one user private database;

(c) running a program which provides the data in a visual form to allow editing of the user private databases during or at the end of said predetermined period; and

(d) storing the edited data in at least one user public database which is accessible by other users of the computer system, allowing further editing by the user or other authorised users who have access.

The invention generally relates to the automated recording and processing of timesheet and other related information using a computer system. The invention is relevant to many fields including but not limited to the following: accounting and billing systems, computer management and administration system's, project management, personal time management, computer supervisory systems, data visualisation.

### BACKGROUND OF THE INVENTION

In most organisations, it is important to management of all levels to have reliable information on how the members of their organisation are spending their time. How many hours have the employees worked this week and therefore how much money should they be paid? Is this project running to schedule and budget? This type of information is considered essential to the running of an organisation for the purposes of payroll administration, project management, resource allocation and general business decision making.

Some of the traditional techniques used to gather this information are as follows: Have each employee fill out a paper or electronic timesheet one a day, week or month. This is common in office environments. Have each employee fill out a running timesheet during the work day, noting down their activities at regular intervals. At the end of the day this running timesheet is collated to calculate the total amount of time devoted to particular projects or customers. This approach is common in consulting firms, particularly in the fields of accounting and law where the interval is often as small as 6 minutes. Log the time each employee arrives at work and leaves each day using a system such as a bundy clock. This is common in factory environments.

It is important to note that although products have been developed which automate the collation of information on what projects have been worked on within an organisation, these schemes invariably rely on the individual's recollection or manually taken notes on what they have done.

As well as managing the human resources of the company, managing the non-human assets of a company also requires accurate information. In today's office environment, where having a computer workstation on every desk is the norm, managing the allocation of computer hardware and software to people in an organisation has become a profession in itself.

Typical tools of the trade are:

A Standard Operating Environment (SOE), which specifies the standard set of software which is installed on each computer in an organisation or department, ie having a standard set of software limits the range of possible problems with which the technical support staff need to be familiar; and a asset database, in which the hardware owned by an organisation is listed along with information such as its physical location, the name of the person who normally uses it and specifications of the machine such as processor model and speed and hard drive and memory capacity, details on installed software may also be kept, depending on the organisation's SOE policy.

### OBJECT OF THE INVENTION

It is an object of the present invention to provide method and apparatus for the automated recording and processing of timesheet and other related information using a computer system.

### DISCLOSURE OF THE INVENTION

According to one aspect of the present invention there is provided a method of compiling data about the use of programs being used on a computer system by at least one user, said method including the steps of:

(a) running a Task Logger program on said computer system to monitor the action of each said user on their workstation to determine the use by each said user during any predetermined period;

(b) entering data to a user private database about the use of each said user, each said user having at least one said user private database;

(c) running a program which provides the data in a visual form to allow editing of said user private databases during or at the end of said predetermined period; and

(d) storing the edited data in at least one user public database which is accessible by other users of the computer system, allowing further editing by the user or other authorised users who have access.

Preferably, once the edited data has been stored in the user public database, a hard copy which is not able to be edited further is stored in the user public database.

Preferably, the method includes the compilations of reports describing in an appropriate level of detail, the use of the computer system of the user, in particular, a timesheet outlining the user's work time during the period, the timesheet being able to be used to allocate time worked to determined charging, etc.

In a preferred form of the invention, the Task Logger program runs continuously as a background process or similar and is configurable to determine the type and amount of data to be collectable.

Preferably, the data collected includes but is not limited to the following: which application or program the user is currently interacting with (if any), which Item the user is currently working on, what type of action the user is currently performing on the Item.

Preferably, the entry to the user private database is made, logging changes made and the time and date of the changes. These changes can be determined by reading and parsing the title of the GUI window with which the user is currently interacting. Other methods of logging the changes are also within the scope of the invention. Preferably, the user private database is password protected.

Preferably, version, product name, vendor name and other such information found in the object code of running applications are used in monitoring user actions at a computer workstation.

In the preferred forms of the invention, the predetermined period can be at the end of each working day, and can be configured to run automatically or user initiated. Naturally other predetermined periods can be used.

Preferably, the program for editing the data allows the user to arrange the data into records such as application, Item, project and activity, etc. Gantt-chart style visualisation is preferably provided for each particular record.

Preferably, the method includes in addition or instead of timesheet information, data characterising the software and/or hardware configuration and usage patterns of computer is workstations being collected. This method includes any business process which uses a system as described to support payroll operations, customer billing, project management, asset management or Standard Operating Environment enforcement. Furthermore, the method can be used for the purposes of supervising a user's activities.

Often the raw logged data will contain large numbers of records each of short duration, which although significant when taken together may impede the user's ability to glean an overview of their work from the data. Therefore, the data can be modified by a number of automated simplification features aimed at combining small pockets of recorded work together to achieve a better overview. Typically the user will also want to remove records of actions which should not appear on their timesheet, such as time spent reading personal email messages. If the configuration has been set up by a system administrator to allow it, this type of record can be removed and the time spent reallocated either automatically or by the user.

Preferably, another editing action which can be regularly performed by the user is the association of specific work done with projects or customers. This is usually achieved by associating each Item with a project. This means that an Item only need be associated with a project when the program is first run after the period in which the user first accessed that Item. Therefore in situations where a large number of distinct Items are worked on by the user over a number of days, weeks or months (as in the case of source code in the field of software engineering for example), the amount of effort required by the user to associate his or actions with projects or customers decreases over time as the program becomes increasingly able to do this automatically.

Once the data have been edited by the program in cooperation with the user, the modified data are stored in the user public database. This database is public in the sense that other users with the appropriate access privileges can view it and possibly (although not usually) edit it. The public database forms the user's historical record of his or her activities and the program allows the user to print a hard copy of a period in this database in a variety of presentation formats, including but not limited to traditional paper personal timesheets, company division timesheets and project progress charts. The method includes the ability to produce in hard copy a report to a customer describing in an appropriate level of detail the work that has been done by the organisation for the customer. Such a printed report can accompany the organisation's invoice to the customer.

Preferably, after a copy is stored in the user public database, the data is also submitted typically into a entity private database of the entity of which the user is a member, usually a department or business unit of an organisation. Once data from the relevant period has been submitted by all members of the entity it is the job of an administrator attached to that entity to run the program and simplify the data, saving it to the entity public database. Depending on depth of hierarchy within the organisation this process of collecting data from the public databases of all member entities into a private database and simplifying and editing this data to form a public database may continue several more times until an organisation public database has been compiled. For single user systems, the first public database may be the organisation public database.

Users are assigned access privileges to view specific public and private databases by the system administrator. With sufficient access privileges, users may gain an overview of all the work that has been done over a given period within the company as a whole as well as in each entity and subenitity constituting it.

Preferably the method is used for payroll administration, customer billing, project and time management and information technology management.

The usefulness of the data gathered as an information technology management tool stems from the fact the system logs the use of applications. If so configured, the system can log other significant details of applications used apart from simply its name. It can log information such as the application's version number, licence code or serial number or even installation directory. In addition, information about the computer hardware could be collected through the system providing a system administrator with a record of the specifications of each user's computer, and which software is installed and which versions of the software is in use. This could prove to be of great assistance in maintaining an asset database, enforcing a Standard Operating Environment or planning a rollout of new software across an organisation.

### BRIEF DESCRIPTION OF THE DRAWINGS

In order to enable a clearer understanding of the invention drawings illustrating an example embodiment are attached and in those drawings:

FIG. 1 is a schematic block diagram of the overview of system components of a computer in a system;

FIG. 2 is an example of a computer screen illustrating a Task Logger running as a background process;

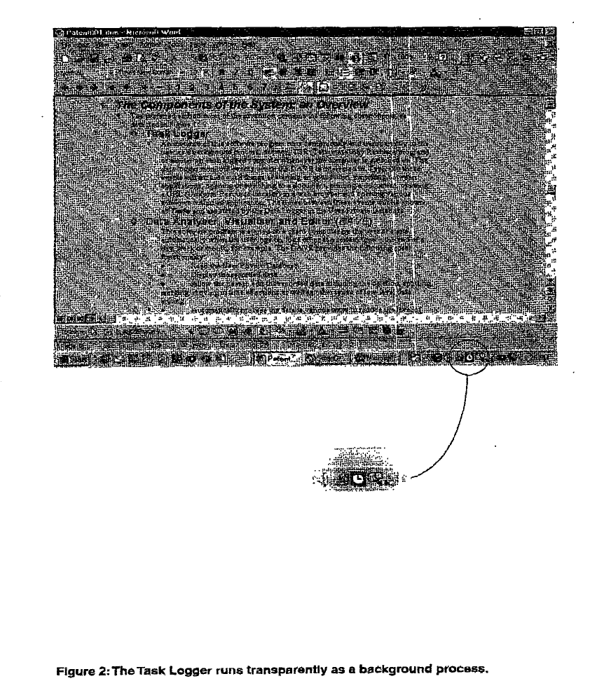

FIG. 3 is an example of a computer screen illustrating a visual display which shows the Tasks in a view similar to a Gantt chart;

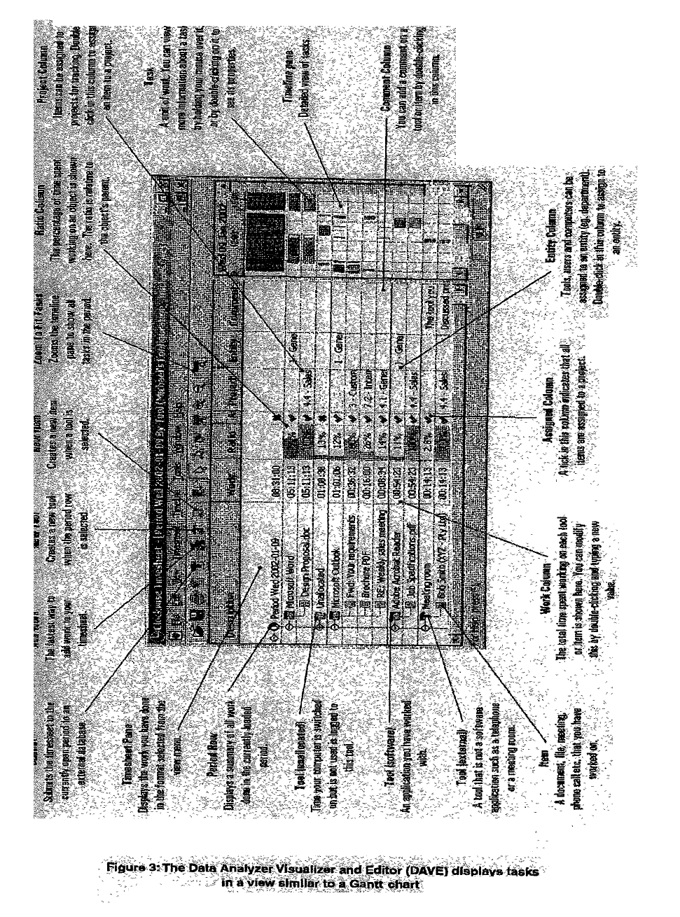

FIG. 4 is a flow chart of the Task Logger program;

FIG. 5 is a flow chart showing the derivation of an Item name from a window caption;

FIG. 6 is a flow chart showing idle time detection using a system event hook;

FIG. 7 is a schematic block diagram of an example of the vertical integration of a company using the method of the present invention;

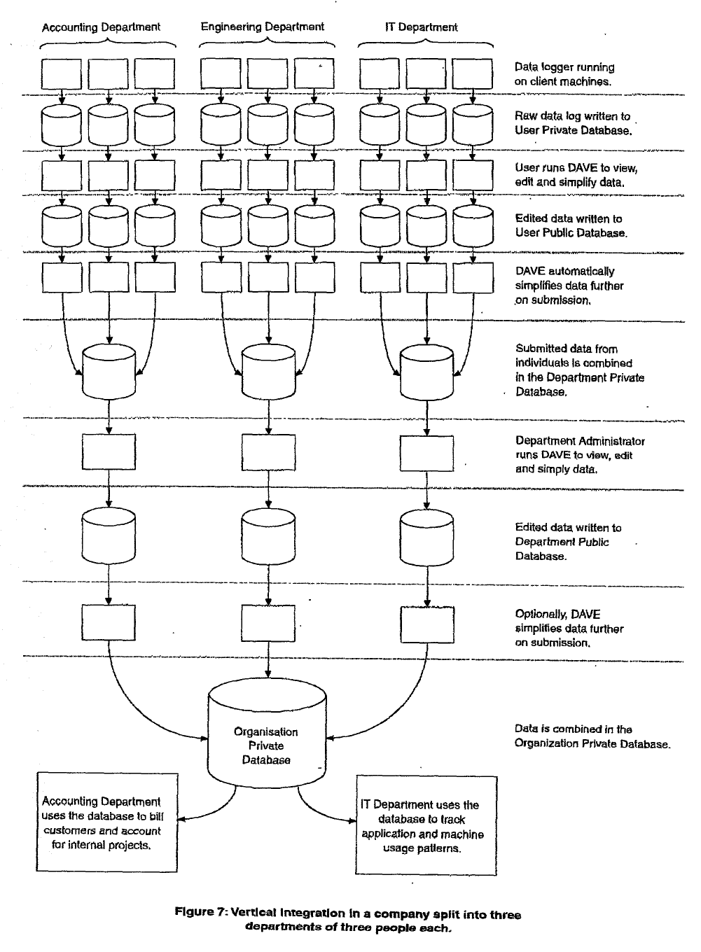

FIG. 8 is a flow chart showing operation of the DAVE at user level;

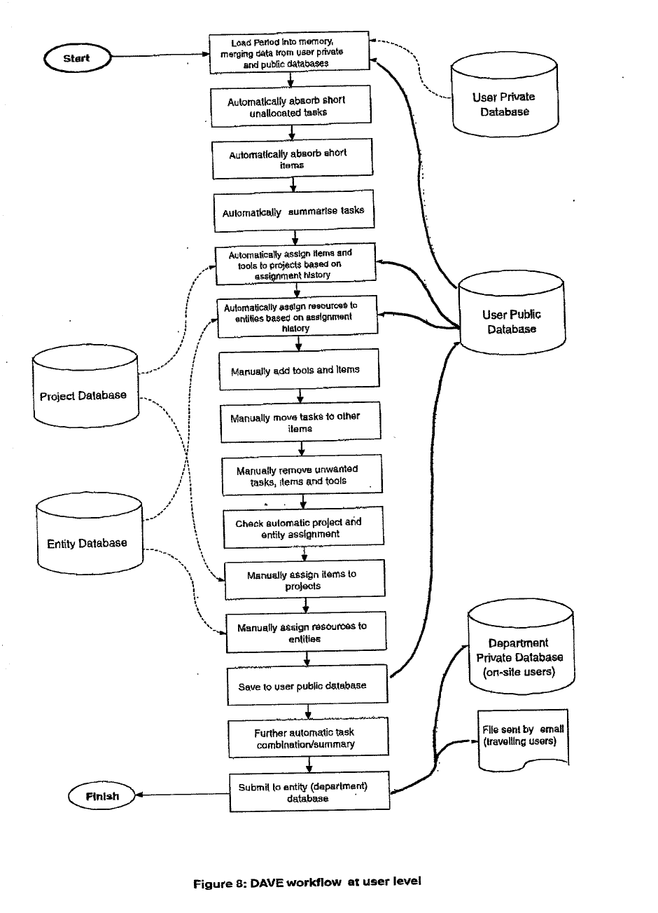

FIG. 9 is a flow chart showing operation of the DAVE at department level;

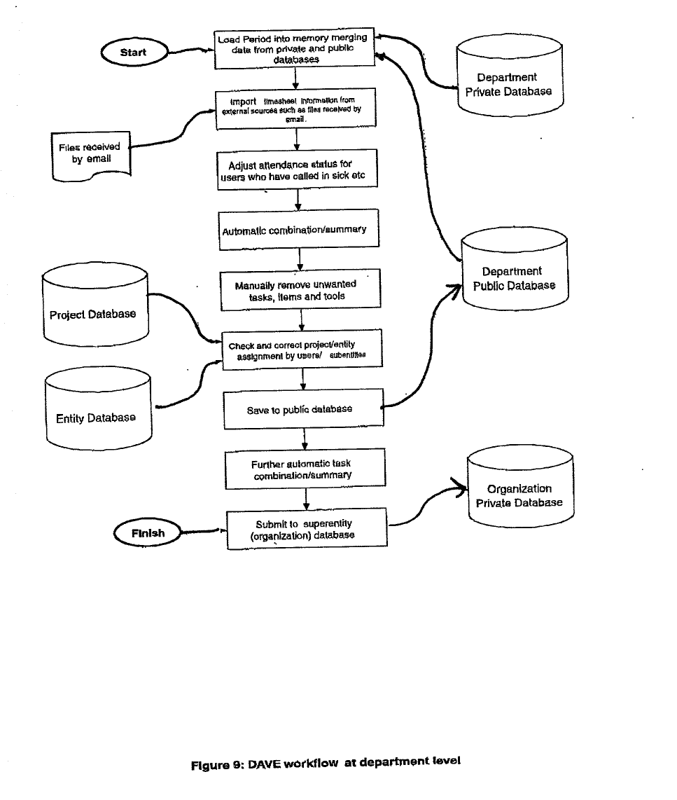

FIG. 10 is a flow chart showing backward Task combination on an Item by the DAVE at user level; and

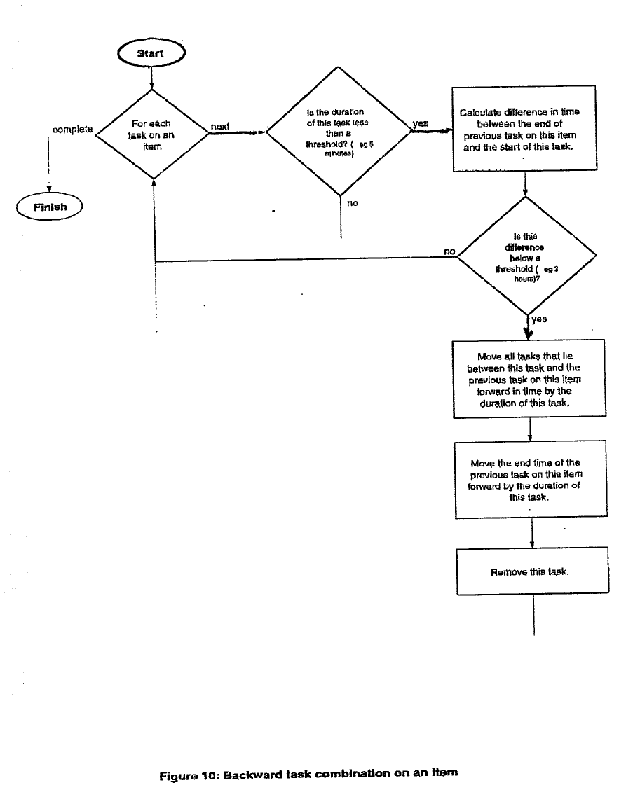

FIG. 11 is a flow chart showing forward Task combination on an Item by the DAVE at user level.

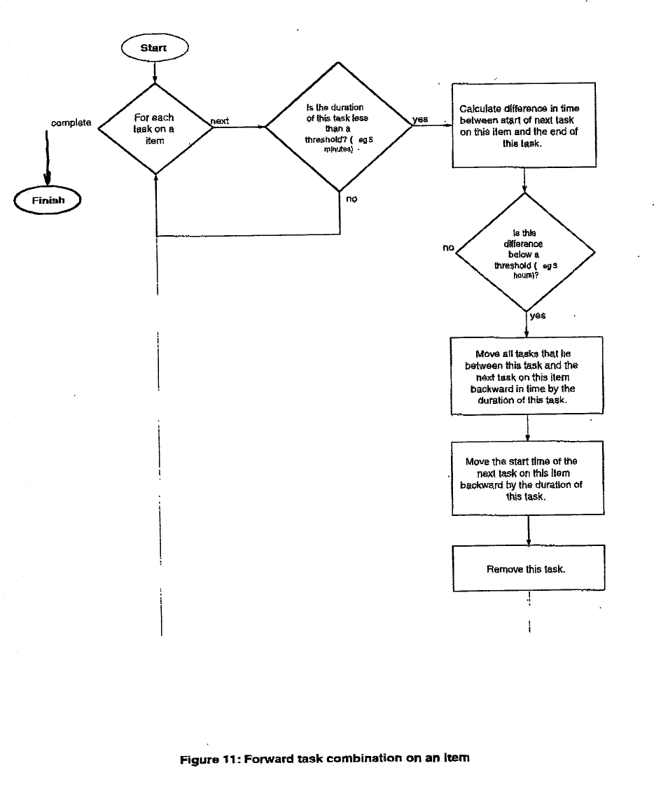

FIG. 12 is a Gantt-chart style diagram depicting an example of the process of absorbing short Idle Tasks. Three Tasks (1, 2 and 3) exist initially. If the duration of the Idle Task (5) is less than a given threshold, these three Tasks are combined into a single Task (4).

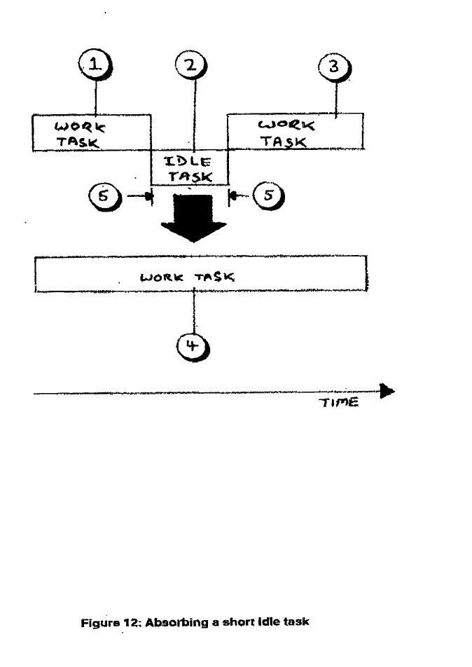

FIG. 13 is a Gantt-chart style diagram depicting an example of the process of summarising several Basic Tasks to form one Summary Task. In this example, six Basic Tasks (1) performed by the same user on the same Item with the same Tool and computer contain five minutes of work in total. The time elapsed between the start of the first Task and the end of the last Task is eight minutes. The process of Task summarisation leaves a single Summary Task with a duration of eight minutes but containing only five minutes' work.

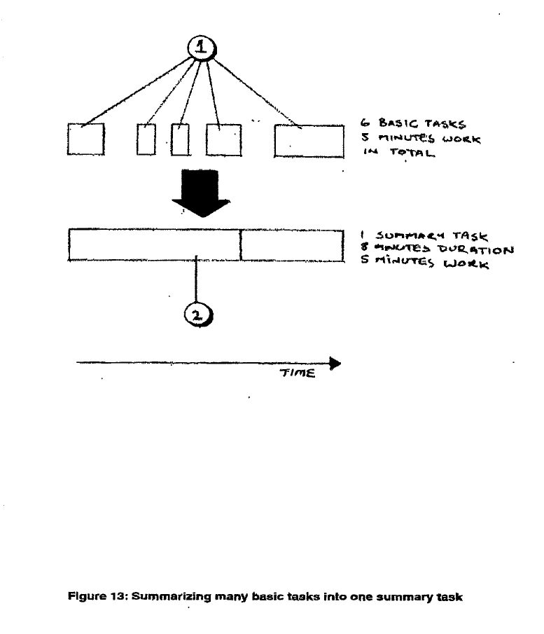

### BEST MODE OF CARRYI.NG OUT THE INVENTION

The preferred embodiments of the invention which are to be described, are used for a method by which information on the actions of an individual, group of people, or other resources can be automatically collected, combined and processed by a computer system, distributed or otherwise, so as to produce timesheeting and other related information useful to a business for purposes including, but not limited to, the billing of clients, internal accounting and information technology systems management. Since much of the data collection and processing can be automated, this represents a significant reduction in the cost and effort required to manage the timesheeting and other related data in many different types of organisations.

In the described preferred embodiments, software programs handle the transparent, automated collection of information on which applications and Items are currently in use on a computer. This data is then optionally visualised and processed to reduce unwanted detail before typically being merged with similar data from other computers, users or company departments. This combined dataset can be viewed to gain an overview of the actions of all the users, computers or departments involved and can also be further simplified and combined with more similar data from other sources to form a progressively higher level overview of the actions of the underlying computers, users or departments.

Furthermore, the automated data collection and visualisation aspect of the invention can be used by software programs to monitor the actions performed on a computer for surveillance purposes. This surveillance is intended for monitoring the actions of an unsupervised child or member of staff, including destinations visited on the internet, but a multitude of other uses are conceivable.

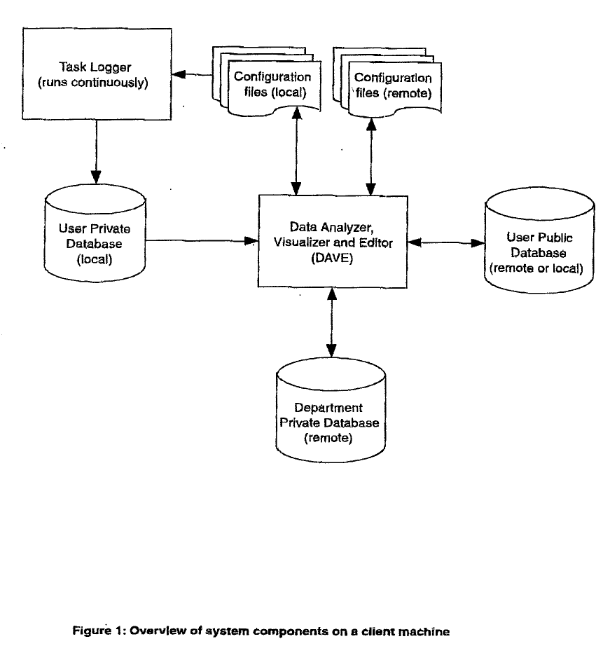

The system as seen in FIG. 1 includes a Task Logger which provides data to a user private database which is local to the user's machine. A Data Analyser, Visualiser and Editor (DAVE) simplifies or edits the data and provides that data to a user public database which other users can access. The data can then be forwarded as required to department or organisation public databases which are remote from the user's machine.

This section introduces some terms and concepts as they are used in this document and in the context of the present invention.

These terms include the following:

Activity

Item

Entity

Group

Period

Project

Task

Basic Task

Summary Task

Tool

User

Activity

An Activity is a general description of the work performed by a User at a given time. It characterises the type of work done without specifying which Tool was used to do it. Examples of Activities include “Documentation”, “Software Development” and “Auditing”. Typically the names of Activities would be shown on a bill presented to a customer, or on a report used internally to gain an overview of what kind of work an organisation has been doing, regardless of which Projects it has been working on.

In the context of the preferred embodiments of the invention one or more Tools are typically associated with all Activity. For example, the Tools “Microsoft Word” and “Adobe Distiller” can both be associated with the Activity “Documentation”. Activities can contain sub-activities. An activity “Documentation”, for example, cant have sub activities “Technical” and “User”.

Item

An Item is an object that is worked on by a Tool. Usually these are data files in a computer system, but the Tool/Item nomenclature also applies to actions outside of the computer system. For example, a phone call to John Citizen might be represented by a. Task record logged against the Tool “Phone” and the Item “John Citizen”. In addition to storing a name for the Item, the system may also maintain a full pathname or other location string such as a Uniform Resource Locator (URL) so that file Items that have the same filename but reside in different directories on disk or at different locations on the World Wide Web may be distinguished.

Entity

An Entity is an organisation, department, or business unit of which Resources, such as Users and Computers, are members. Entities can contain subentities. For example, the user “Jane Citizen” might be a member of the Entity “Engineering Department”, which is a subentity of the Entity “XYZ Corp”.

Group

A Group is a collection of Users who have a common set of access privileges with respect to the various databases. Like Entities, Projects and Activities, Groups can have sub-Groups, which inherit the privileges of a parent Group. For example, the group “Administrators” can have the right to view the edit the data in any public Database within an organisation. Its sub-Group “Engineering Administrators” can additionally have the right to edit the data in the Engineering department's Department Private Database to produce the Department Public Database.

Period

Although period can be generally taken to have its usual meaning, something specific is meant by a Period in the context of a Data Analyser, Visualiser and Editor (DAVE). A Period, when talking of the DAVE, is a section of time that is being analysed, visualised or edited as a unit. Typically the DAVE will be used to operate on periods of a day, a week or a month. In the preferred embodiment of the invention, a Period is a temporary contiguous section of a database or merged databases loaded. into memory. Normally when a Period is loaded, the DAVE will attempt to load Tasks from the Public Database for each User. If, for a User, the Public Database does not contain timesheet data for the entire period, the DAVE will load Tasks from the Private Database for that User for those parts of the period which are not covered by the Public Database.

Project

In the terms of this invention, a Project is a heading to which the time of a User can be attributed or “billed”. This is done by assigning Items to the Project. Projects can be internal to a company or can include, for example, all the work done for a particular customer. Projects can contain other sub-projects. They can be completed at a particular milestone or be of an ongoing or recurring nature. Some example Project names include: “Circuit board layout”, a subproject of “CD Player Model 519”, “IT System Administration” or “XYZ Incorporated”.

Resource

A resource is a User, computer or Tool. A Resources can be assigned to an Entity for the purposes of tracking work by Entity and for asset management.

Task

A Task is the system's basic unit of data storage and records a period of time during which a User was performing the same action under the same conditions. It should not be confused with an operating system task. A Task record contains the time that a User started performing the Task, the end time and the amount of work that was actually performed on that Task by the User between the start and end times. In certain cases this amount of work can be different to the Task's duration (see below). A Task record also stores some or all of the following information:

The title of the window that was active during the period.

Which application was being used.

Which Item was being worked on.

Which User performed the Task.

Which Computer the Task was performed on.

Other information.

A Task record is used in two different ways within the system:

Basic Task

A Basic Task is a Task whose amount of work is equal to its duration, that is, the difference between its start and end times. A Basic Task logged against a User implies that the User was focussed solely on performing this task at the time and was not working on anything else significant. Basic Tasks are generated by the Task Logger and are usually found in the User Private Database. An example of the kind of information that may be gleaned from a Basic Task record is as follows: From 12:19:05 until 12:21:10 on Apr. 10, 2001, Jane used only Microsoft Word working on the Item Contract5.doc with the window entitled “Insert Tables” open.

Summary Task

A Summary Task is a Task whose amount of work is not equal to its duration, that is, the difference between its start and end times. A Summary Task logged against a User implies that the User was performing other Tasks at the same time. An example of the kind of information that may be gleaned from a Summary Task record is as follows: In the week beginning Apr. 8, 2001 Jane Citizen worked a total of 28 man-hours on the Item foo.c using the application Microsoft Visual C++.

Tool

A Tool is used by a User to do work on an Item. Usually a Tool is a software application running on a computer (eg “Microsoft Word”) but the term. is also used to denote tools used by a User outside the context of the computer (eg “phone”, “fax”, “photocopier”, “soldering station”). A Tool may be assigned to an Activity which describes the work a User does with that tool in general terms.

User

A User is an individual person whose work is tracked by the system.

The following processes are performed by each User or by a software program at each client workstation in an organisation:

User Level Processes

The processes described in this section are those that are performed by a user or by software programs on behalf of that user in the typical use of the preferred embodiment of the invention. The operation of the invention can be split into the following six parts:

Collect

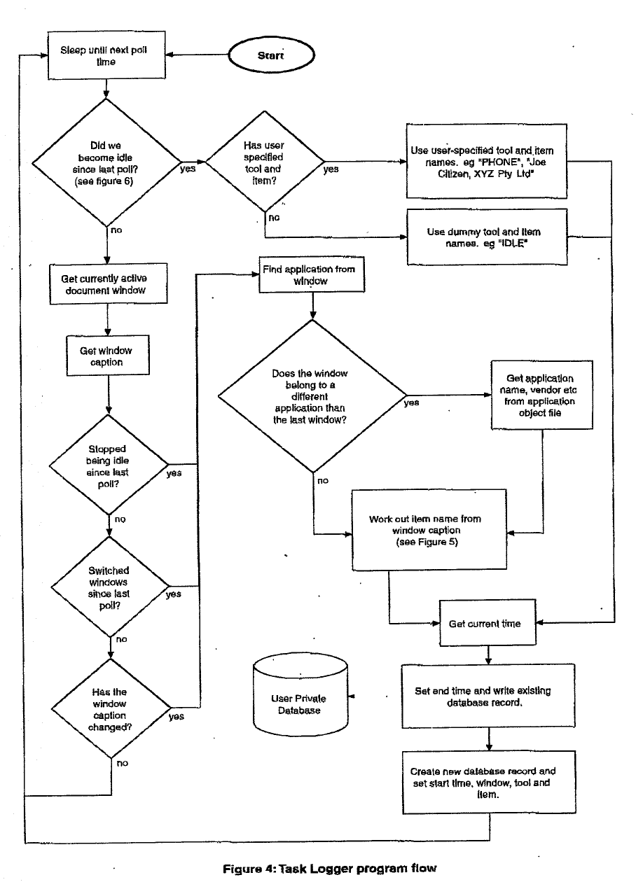

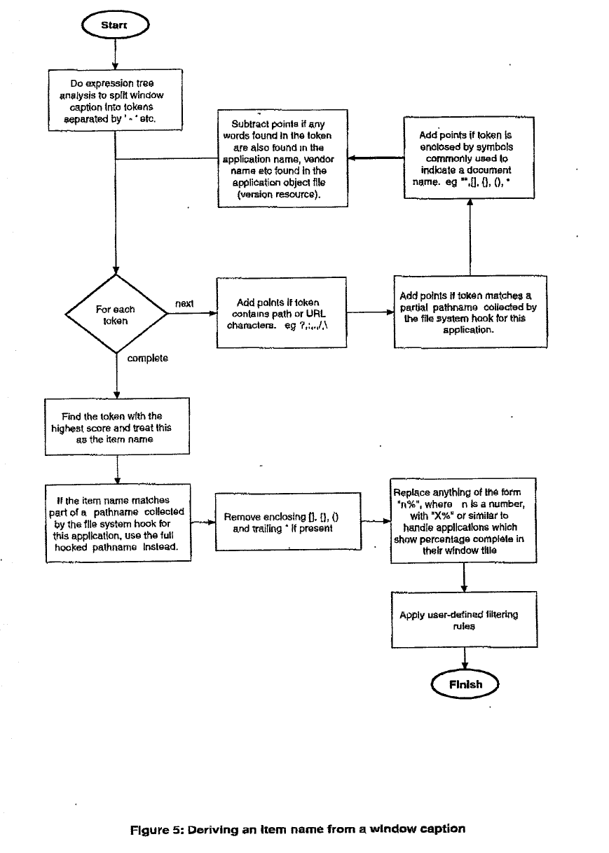

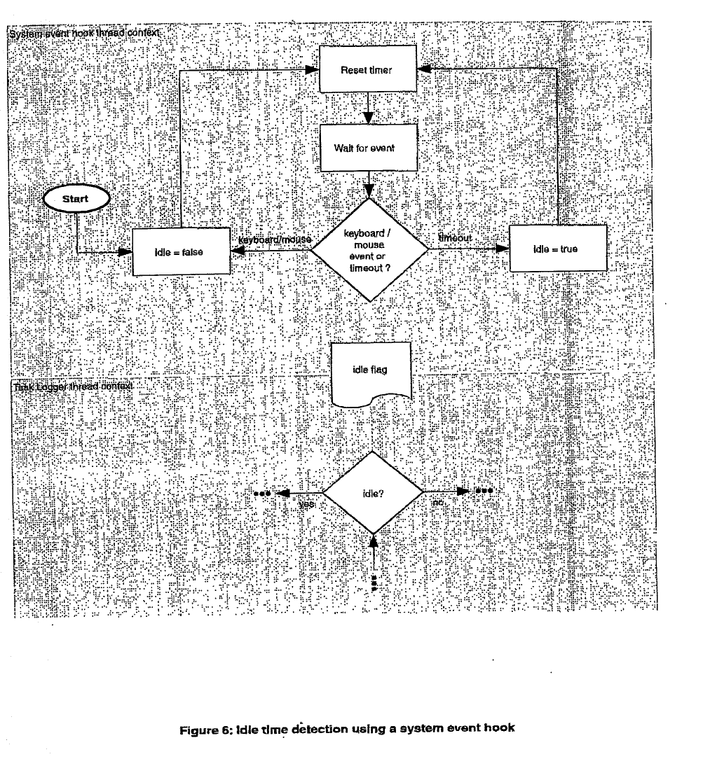

The first and most fundamental aspect of method is the automated collection of timesheet information. This step is performed by the Task Logger, a software program which runs as a background process on each User's machine as seen in FIGS. 4 to 6. The purpose of the Task Logger is to monitor with which user interface window, Tool and/or Item a user is currently interacting and store this information in the User Private Database.

In the case of the preferred embodiment of the invention running under one of the Microsoft Windows operating systems, the monitoring is achieved by periodically polling the current foreground window using the Windows GetForegroundWindow( ) API function. The resulting window handle is then used to determine the caption or title of the window using GetWindowText( ) and to identify the process that owns the window using the GetWindowThreadProcessID( ) function. This process identifier is turn used (through the Toolhelp32 or PSAPI API functions) to locate the application's object code file from which various information about the application can be read using GetFileVersionInfo( ) and VerQueryValue( ).

The window title or caption of the application's main window can be used to determine which Item the user is working on using the method described below. For applications which use the Microsoft Windows Multiple Document Interface (MDI), the application's window hierarchy can be inspected by the logger to determine which document (child) window the user is currently interacting with. The window title of the active document window should be used to determine the Item name using the method described below. If, however, the active document window is maximized, the application's main window title should be used.

Split the string into subsections whenever a hyphen surrounded by whitespace ( ) or other separating mark is found. For example the window title “Patent001.doc-Microsoft Word” is split into the strings “Patent001.doc” and “Microsoft Word”. To ensure that nested brackets and other symbols are handled correctly, the string can be split into an hierarchical expression tree similar to those used in compilers for high level computer programming languages. For example, the window title “Microsoft Visual C++-(run-foo.c)” is split into the subexpressions “Microsoft Visual C++” and “(run-foo.c)”, where the second expression is then further broken down into the subexpressions “run” and “foo.c”.

Next, analyse each substring and allocate points to it according to the following rules. If a substring is likely to be the name of an Item positive points are added. If it is likely to be the application name negative points are added.

If a substring is enclosed in any kind of quotation marks, brackets, braces, parentheses or similar enclosing marks it is likely to include the name of an Item. Many applications follow this pattern.

If a substring (after any enclosing marks are removed) ends in an asterisk (*) it is likely to be an Item since many applications use an asterisk after an Item name to indicate that the item is currently unsaved.

If a substring contains characters normally used in a pathname or UPL such as (*, ?, :, /, \, .) it is probably an Item name, ep. “Patent100.doc” would be awarded a point because of the presence of a period (.).

If a substring contains words or tokens also found in the file description, product description, company name or copyright statement or other similar string in the application's object file it is probably the name of the application eg, for the substring “Microsoft Word” two points would be deducted because two words were found in common with the file description string for the application, which reads “Microsoft Word for Windows”.

Once all substrings have been analysed, find the one with the highest score and assume this to be the Item name.

The Task Logger is generally set up to start automatically when the computer workstation starts or when a user logs on. The Logger polls at regular intervals (1 second works well) to determine whether anything has changed since the last poll. When a change is detected, a record is written to the User Private Database. This record stores the start and end times of the Task, a way to identify the application, and a way to identify the Item. It can also store the full window text associated with the Task and possibly other information such as the current timezone offset from UTC (GMT), the user name, computer name, application version number and application install path.

The Logger can also be configured to log to the database less frequently than its polling frequency. So, for example, the logger can examine the user's activities once per second but only log changes if they have occurred every 5 seconds. In the case that more Task changes are detected than are logged, the window name, application name and Item name that we used most during the log period are stored in the database as taking up the entire log period.

The Logger also detects periods of inactivity at the workstation. After the keyboard and mouse have not been used for a period of time the Logger begins to log time to a Tool called “Unallocated” or similar. Idle time can be detected in the preferred embodiment using one or more of the Windows message hooks through SetWindowsHookEx( ).

It is useful to have the full pathname of document files worked on by a User since it allows the DAVE to distinguish between files with the same filename located in different directories. Additionally, the DAVE may be able to automatically determine which project an Item should be assigned to based on its location in the file system. In such a scenario, a user or administrator could specify that all files in a certain directory should be assigned to a particular project.

To this end, the Logger can also have the ability to hook into the file system to monitor file accesses by each application. In the preferred embodiment of the invention running on the Microsoft Windows 95, 98, and Me series of operating systems this can be achieved with a Virtual Device Driver (VXD) in conjunction with the VXD service IFSMGR_InstallFileSystemApiHook. On the Microsoft Windows NT, 2000 and XP series of operating systems this can be achieved using a file system filter kernel mode driver. Regardless of which series of Microsoft Windows operating system is used, the Logger can communicate with the file system hook driver through the DeviceIOControl( ) API to receive information about which files are being accessed by each application. This information can contain the full pathname of each file.

The Logger can use this information from the file system hook in conjunction with the window title parsing scheme described above to determine the full pathname of each document file worked on. This can be done by matching fragments of an application's window title believed to constitute the name of a document file (as discussed above) against a list of pathnames known to have been accessed by the application recently. When a partial pathname or filename parsed from a window title matches part of a recently accessed full pathname received through the file system hook, the Logger save the full pathname to the User Private Database as the Item's name or locator.

Also provided through the Logger is the ability to specify a Tool external to the computer. By clicking on a menu option or button or pressing a hotkey or similar the Logger can be made to log time to a particular Tool or Item. This is especially useful when a phone call is made or received by the user. In the case of the preferred embodiment, the user clicks on the Task Logger icon in the system tray to open a window which allows him or her to enter the Tool being used, for example, “PHONE” and specify an Item name. In the case of a phone call the Item name may be the name of the party telephoned or perhaps a telephone number. Anything that will enable the user and the DAVE to later associate that call with a project. In the case that the user's telephone system is integrated with the computer workstation, Logger may be able to automatically log telephone calls in a similar manner to actions on the workstation itself.

Simplify

At regular intervals, usually a day, week or month, the user runs the Data Analyser Visualiser and Editor (DAVE). The DAVE may also be configured to run automatically at the beginning or end of a working day. The DAVE displays to the user the timesheet data collected in the User Private Database for the period in question. The DAVE now assists the user in the removal of unwanted detail in these data.

Some of the DAVE's simplification functionality can run on the data automatically as it is loaded from the database, others may need to be triggered by the user. The data simplification functions are as follows:

Task Deletion

The user may choose to delete a group of tasks. The DAVE removes these tasks from the data in memory and fills the resulting gap in the timeline with the surrounding tasks. If a deleted task is both immediately preceded and immediately succeeded in time by other tasks, those two tasks share half of the time of the deleted task. In the case that a deleted task is only preceded, the preceding task subsumes all of the time allocated to the deleted task. Similarly the successor of a deleted task with no predecessor subsumes all of the deleted task's time. A preceding task subsumes all or part of a deleted tasks time by having its end time moved forward. A succeeding task subsumes all or part of a deleted task's time by having its start time moved backward. Alternatively, the task may simply be removed without modifying any of its surrounding tasks.

Tool and Item Deletion

A user may decide that he or she does not want tasks logged against a particular Tool or Item to appear on his or her timesheet. The DAVE provides a method for removing a Tool or Item from the data. Tasks logged against that Tool or Item are then deleted using the previously described methods of Task Deletion.

Window Title Stripping

The window title information can be stripped from the data if this is not considered important and any Tasks logged against the same Tool Item, User and Computer that are adjacent in time combined.

Task Combination

The DAVE can automatically combine sets of short tasks distributed over time into longer tasks. This serves to reduce the total amount of data in the system and affords a better overview of what the user actually did during the Period. The start times of all Tasks in the database are no longer completely accurate after a combination operation but the total amount of time logged against each Tool and Item remains consistent. Tasks A and B can be combined if the following rules are satisfied:

1. Task A is shorter than some threshold. A typical threshold value is 5 minutes.

2. Task B can be found that is logged against the same Tool and Item as Task A.

3. The distance in time between Task A and Task B is less than some threshold, typical set at several hours.

If Task A is to be moved backward in time to combine with Task B, the following is done:

1. Remove Task A from the timeline, noting its duration.

2. Move all Tasks between the end time of Task B and the start time of Task A forward in time by the duration of Task A.

3. Move the end time of Task B forward by the duration of Task A.

If Task A is to be moved forward in time to combine with Task B, the following is done:

1. Remove Task A from the timeline, noting its duration.

2. Move all Tasks between the end time of Task A and the start time of Task B backward in time by the duration of Task A.

3. Move the start time of Task B backward in time by the duration of Task A.

Absorb Short Idle Tasks

Many types of office work are characterised by bursts of work on a computer separated by short bursts when the computer is not used because the user is, for example, reading hard copy reference material, writing a memo by hand or collecting a hard copy from a printer. We make the assumption that whenever a user is not using their computer for a short time, they are doing work away from their computer that relates to the work that they were doing on their computer before and after their computer was idle. This work away from the computer should be billed or attributed to the same project or customer that the user was working for on the computer so it is a useful simplification to forget that the work away from the computer ever happened and instead report that the user was working on the computer the whole time.

Therefore, the DAVE provides a function to automatically remove short Idle Tasks that have been collected by the Task Logger on the Unallocated Tool. All tasks on the Unallocated Tool are examined. Tasks that meet the following criteria are absorbed:

1. The duration of the task is less than a threshold, for example, 5 minutes.

2. The User who was idle worked with the same Tool and Item both before and after the Idle Task.

Tasks that meet these criteria are absorbed using the following method: We have, say, tasks A and C, both worked on with Tool T on Item I by user U. Task B is an Idle Task and is the only task “performed” by user U between tasks A and C. Task B starts at the end time of task A and ends at the start time of task C. We absorb tasks B and C into task A as follows:

1. Set the end time of task A to the end time of task C.

2. Add the amounts of work from tasks B and C to task A.

3. Delete tasks B and C.

Absorb Short Items

Items which have only had a very small amount of work done on them can be removed automatically by the DAVE, since they normally constitute unwanted detail. The DAVE uses the following method to mark short tasks on short Items for absorption:

1. Reset the absorption flag on all tasks in the period.

2. For each Item, add up the total amount of work from all the tasks that have been done on that Item.

3. If that total for the period is less than a threshold, for example, 2 minutes, mark the Item for absorption by setting the absorption flag on each task associated with the Item.

Once all the Items have been examined and appropriate tasks marked for absorption, the DAVE then sets about absorbing each marked task into the task preceding or succeeding it as follows:

Task Summarisation

Another way of removing unnecessary detail is to combine several Basic Tasks into one Summary Task. The DAVE provides a function to automatically summarise by analysing all tasks and combining each pair of tasks that meet the following criteria:

1. The tasks are consecutive on the same Tool, Item, User and computer.

2. The gap between the two tasks is smaller than a given threshold, for example, one hour.

3. Optionally, the window titles or other similar information stored on the two tasks must match.

To combine two such tasks A and B into a summary task A:

1. Set the end time of task A equal to the end time of task B.

2. Add the amount of work in task B onto the amount of work in task A.

3. Delete task B.

Assign

Once the data have been simplified, they must then be assigned to Projects. Normally the user assigns all Tasks on a particular Item to be associated with a particular Project using the DAVE. Other methods of assignment exist including the assignment of all Items worked on with a particular Tool to a Project and the assignment of all Items that are stored in the same directory on disk to a Project.

When the user opens a Period of the User Private Database in the DAVE, Tasks logged against Tools or Items that have been assigned to a Project in a previous Period are automatically assigned to that same Project. Thus the same Item worked on by a user who runs the DAVE daily over the course of several days only need be assigned to a Project on the first day.

Submit

The user's goal when he or she uses the DAVE each day, week or month (as the case may be for the particular organisation) is to:

Remove unwanted detail.

Ensure that all work performed during the Period in question is correctly assigned to a project.

Once the user is satisfied that these conditions have been met, he or she uses the DAVE to submit the data. The submission process involves saving the modified data to the User Public Database. Once the user is satisfied that the data in the User Public Database is final for a given Period, the status of that period is marked “Closed” in the User Public Database. As well as the Closed status, other possible statuses could include “Open”, “Out of Office”, “Annual Leave” and “Sick Leave”.

Depending on the configuration in use by the organisation, when a user closes a Period of the User Public Database the DAVE can further simplify that data and merge it directly into the Entity Private Database of the User's parent Entity.

For a single-user organisation, a contracting software engineer for example, the manipulation of timesheet data ends with submission into the User Public Database and the data is Reported on and Analysed directly from there. For a user in a larger organisation the data will be combined with data from other uses as described in the “Entity Level Processes” section.

Report

The user can generate several types of hard-copy report from the User Public Database, printed by the DAVE. These include:

A traditional paper timesheet for internal use within the organisation.

A report of work completed on a particular project or for a particular customer. In the case of a single-user organisation, this report is designed to accompany an invoice sent to a customer.

Analyse

At any point the user can refer to previous work that he or she has done by using the DAVE to view either their User Private Database or their User Public Database. This could be used, for example, to find when an Item was last opened by the user.

Entity Level Processes

While the previous section discussed the processes that occur at the individual user level in an organisation, the processes are similar at the level of a larger entity such as department, business unit or an entire company.

All users in a department submit their timesheets into their department's private database. It is the responsibility of the department manager, Supervisor or administrator to periodically run the DAVE, load the Department Private Database, make any desired changes, save these modified data to the Department Public Database and finally submit them to the Organisation Private Database.

Once the data from each department have been submitted into the Organisation Private Database a manager, supervisor or administrator for the entire organisation runs the DAVE, load's the Organisation Private Database, makes any final organisation-wide edits and saves to the Organisation Public Database These final data in the Organisation Public Database can then be used as a basis to bill clients, pay employees, manage projects and assets etc at an organisation-wide level.

In smaller companies without departments, the users may submit directly to the Organisation Private Database. In single user scenarios, the User Public Database may be used directly to bill clients and to manage projects.

The Components of the System

Task Logger

An instance of this software program runs continuously and transparently to the user as a background process, daemon, TSR (Terminate Stay Resident program) or similar on each logged computer whenever the computer is switched on. The data logger monitors events which the DAVES is interested in. Typically these events will include such things as starting an application, switching between applications, opening or switching to an Item, printing a document, opening a URL (Uniform Resource Locator) in a web browser and opening various windows within an application. The times between these events will be known as Tasks and are stored by the Data Logger in the User Private Database.

Data Analyser, Visualiser and Editor (DAVE)

This software program is started on a client computer by the user or starts automatically when the user logs on, logs off or at a certain time—the end of a day, week or month, for example. The DAVE provides the following core functionality:

Read the from a Private Database and a Public Database.

Display the recorded data for analysis.

Allow the user to edit the recorded data including the deletion, splitting, merging, moving in time of actions as well as other types of low-level data editing.

Automatically process the data is various ways to reduce the level of unwanted detail. This includes stripping window details, collating Tasks in time.

Check database consistency repair errors.

Allow the user to assign Tasks, Items and Applications to a Project and/or Activity.

Allow the user to save to a Public Database or submit to an Entity Private Database.

Allow the user to export timesheet information to file for email, reporting or otherwise.

User Private Database

This is where the Task data produced by the Data Logger is initially stored. It contains all the Tasks logged on a particular machine for a particular user and is password protected and accessible only to the user whose actions it contains. Since multiple users may use the same machine over time this implies that a separate private database must be maintained for each user of the machine. Typically the User Private Database is located locally on the hard disk of the machine performing the logging. However, the Task Logger or DAVE can provide a way to move or consolidate data logged on a computer by a user other than the normal user of the machine across a network to a database on a server or to the user's normal machine.

User Public Database

This is where the edited Task data produced by the DAVE is initially stored. Typically the User Public Database is located local to each user's machine or on a server. This data constitutes a user's historical record of his or her edited timesheet data.

Entity Private Database

Once each user has finalised their timesheet and saved the results to their User Public Database, they can also use the DAVE to submit to an Entity Private Database. If the entity contains subentities, the manager, administrator or supervisor of each subentity submits timesheet data for that subentity into the Entity Private Database. The Entity Private Database is, therefore, a collection point for timesheets for all users in an entity, such as a department or for the entire organisation. Typically an Entity Private Database is located on a server and is writable by all the users in the entity. Administrators, supervisors or managers for the entity typically also have read permissions on it.

Entity Public Database

An Entity Public Database, such as a Department Public Database or an Organisation Public Database, stores timesheet data for all users in the entity after an administrator, supervisor or manager of that entity has used the DAVE to edit them. An Entity Public Database is typically located on a server and can be accessed only by administrators, supervisors and managers of the entity.

Project Database

The Project Database stores the hierarchical chart of projects that an organisation works on. Typically the Project Database is located on a server and can be read by everyone in the organisation. Administrators and managers would typically also have access privileges to modify the database by adding, removing or modifying projects.

Activity Database

The Activity Database stores the hierarchical chart of activities that an organisation uses. Typically the Activity Database is located on a server and can be read by everyone in the organisation. Administrators and managers would typically also have access privileges to modify the database by adding, removing or modifying activities.

Entity Database

The Entity Database stores the hierarchical chart of entities in the organisation. Typically the Entity Database is located on a server and can be read by everyone in the organisation. Administrators and managers would typically also have access privileges to modify the database by adding, removing or modifying entities.

The foregoing describes only some embodiments of the present invention and modifications obvious to those skilled in the art can be made thereto without departing from the scope of the present invention.

1. A method of compiling data about at least ones user's work on a computer system by running a Task Logger program on said computer system to monitor the action of each said user on their workstation to determine the use by each said user during any predetermined period.

2. The method according to claim 1 wherein a DAVE program or similar is run to allow editing and reporting on the data compiled by the Task Logger.

3. The method according to claim 2 wherein each said user runs the DAVE program or similar to edit his or her own compiled work data.

4. The method according to claim 2 wherein a supervisor runs a DAVE program or similar to edit the compiled work of all users in a department or organization.

5. The method according to claim 2 wherein the DAVE program shows the data visually.

6. The method according to claim 1, wherein the user enters additional tasks into the compiled data as they happen by using a stopwatch type interface.

7. The method according to claim 6, wherein the entered tasks include phone calls and other work not involving the computer.

8. The method according to claim 1, wherein the method includes the compilations of reports describing in an appropriate level of detail, the use of the computer system of the user, in particular, a timesheet outlining the user's work time during the period, the timesheet being able to be used to allocate time worked to determined charging and the like.

9. The method according to claim 8, wherein the method includes the automatic calculation of billable amount, payroll costs and profit directly from the compiled data for each project or customer at the end of the day, week, month or other period.

10. The method according to claim 1, wherein the Task Logger program runs continuously as a background process or similar and is configurable to determine the type and amount of data to be collectable.

11. The method according to claim 1, wherein the data collected includes but is not limited to the following: which application or program the user is currently interacting with (if any), which Item the user is currently working on, what type of action the user is currently performing on the Item.

12. The method according to claim 11, wherein the Task Logger periodically parses the window title of some or all GUI windows with which the user is interacting to determine the name of the Item that the user is currently working on.

13. The method according to claim 12, wherein the Task Logger records changes when the user is found to be working with a different application, window or Item, also recording the time and date of such changes.

14. The method according to claim 11, wherein version, product name, vendor name and other such information found in the object code of running applications are used in monitoring user actions at a computer workstation.

15. The method according to claim 2, wherein the DAVE program is run at the start or end of each working day, week or month, and is configured to run automatically or user initiated.

16. The method according to claim 2, wherein the DAVE program allows the user to rearrange the Task records so as to modify which application, Tool, Item, project and activity and the like each Task record is associated with.

17. The method according to claim 16, wherein Gantt-chart style visualisation is provided for each particular Task record.

18. The method according to claim 1, wherein the method includes in addition or instead of timesheet information, data characterising the software and/or hardware configuration and usage patterns of computer workstations being collected.

19. The method according to claim 8, wherein the method includes any business process which uses a system as described to support payroll operations, customer billing, project management, asset management, Standard Operating Environment enforcement, or time management.

20. The method according to claim 1, wherein the method is used for the purposes of supervising a user's activities.

21. The method according to claim 2, wherein raw logged data contains large numbers of records some of short duration, whereby the data is modified by a number of automated simplification means.

22. The method according to claim 2, wherein the user can remove records of actions which should not appear on their timesheet, such as time spent reading personal email messages.

23. The method according to claim 2, wherein, an editing action performed by the user is the association of specific wok done with projects or customers.

24. The method according to claim 23, wherein each Item is associated with a project whereby the Item only need be associated with a project when the program is first run after the period in which the user first accessed that Item.

25. The method according to claim 3, wherein once the data have been edited by the DAVE program in cooperation with the user, the modified data are stored in the user public database.

26. The method according to claim 25, wherein a file Item is automatically assigned to the project based on the directory position in the file system.

27. A method of compiling data about the use of programs being used on a computer system by at least one user, said method including the steps of:
(a) running a Task Logger program on said computer system to monitor the action of each said user on their workstation to determine the use by each said user during any predetermined period;
(b) entering data to a user private database about the use of each said user, each said user having at least one said user private database;
(c) running a program which provides the data in a visual form to allow editing of said user private databases during or at the end of said predetermined period; and
(d) storing the edited data in at least one user public database which is accessible by other users of the computer systems allowing further editing by the user or other authorised users who have access.

28. The method according to claim 26, wherein once the edited data has been stored in the user public database, a hard copy which is not able to be edited further is stored in the user public database.

29. The method according to claim 3 wherein once the data have been edited by the DAVE program in cooperation with the user, the modified data may be submitted into a central entity private database which contains data on work done by all users in a department or organization.

30. The method according to claim 4 wherein once the data for an entire department or organization have been edited by the supervisor the data are stored in an entity public database.

31. The method according to claim 3 wherein once the data for an entire department have been edited by the supervisor the data, may be submitted into a further entity private database which contains data on work done by all departments in an organization.

32. The method according to claim 1, wherein the logged data is stored by the Task Logger in the user private database.

33. The method according to claim 32, wherein other methods of logging the changes include the user private database being password protected.

34. The method according to claim 12, where product name, vendor name, copyright statement and other information found in the object files of applications is used to assist in extracting the name of an Item from a GUI window title.

35. The method according to claim 12, where information obtained from the operating system on which files are being accessed by applications is used to assist in extracting the name of an Item from a GUI window title.

36. The method according to claim 1, where keyboard and mouse activity is monitored to detect periods when the computer is not being used and logging the start time, date and duration of such periods.

37. The method according to claim 12, where information obtained from the operating system on which files are being accessed by applications is used to determine the full path name of the Item.
